(19) United States
(12) Patent Application Publication
(10) Pub. No.: US 2004/0264166 A1
(43) Pub. Date: Dec. 30, 2004

(54) Lighted soft device for automobile equipment

(76) Inventor: Tseng-Lu Chien, Shi-Chi Town (TW)

Correspondence Address: BACON & THOMAS, PLLC, 625 SLATERS LANE, FOURTH FLOOR, ALEXANDRIA, VA, 22314

(21) Appl. No.: 10/285,451

(22) Filed: Nov. 1, 2002

(51) Int. Cl. F21V 9/16

(52) U.S. Cl. 362/84; 362/267; 362/487

(57) ABSTRACT

A lighted soft device for automobile equipment includes electro-luminescent element(s) to provide illumination and add to driving safety. A lighted soft device may be used for a safety belt, steering wheel, seat cover, seat pillow, dash board mat, or car front bra, and may be made of a textile, garment, cloth, or plastic material to offer protection from sun, weather, moisture, heat, water, rust, and scratches to keep said equipment as durable as possible. The electro-luminescent element may be a panel, strip, tube, fiber, twisted panel, etc.

### BACKGROUND

The current invention uses a low-cost electro-luminescent (EL) element to make a lighted device having a super low cost, simple production procedure, and super brightness. The invention thus provides a soft lighting device for automobile equipment such as a safety belt cover, steering cover, dash board cover, seat cover, seat pillow cover, front body cover, which will provide a driving accent light for the car user. Such a soft cover offers protection for equipment to prevent damage caused by sun beams, ultra-violet rays, water, humidity, scratches, sand, rocks, and bugs. Not only does such a cover offer protection, but it also offers other features such as comfortable seat belt fastening, adding a non-slip function for the dash board cover and comfort to the seat cover and seat pillow, and cosmetic changes to the front car body. The light device on such a soft cover adds to the versatility of these applications.

The current invention provides a way to make any shape of EL light device by a simple process.

The current invention also provides a way to improve the cosmetic appearance of the EL panel's silkscreen.

The current invention also provides a treatment to solve assembly problems for a lighted soft device. The current invention also teaches a method of decreasing wall thickness for a plastic tube to overcome bending problems.

The current invention also teaches a way to incorporate a soft cover with a tubular EL panel light device.

The current invention also teaches a way to make a soft cover device in which selected areas include a with phosphor coated EL element.

Finally, the current invention provides a way to make a cover device having a front sheet with a window or opening design.

The current invention teaches a way to have a super brightness lighted soft device for automobile equipment at low cost by providing selected areas of the soft device with a phosphor coating and a front sheet window opening to enable the light to be visible to viewers. This is a great technical advance with respect to cost considerations. In addition, the invention can add multiple color, brightness, and motion effects for the soft lighted device.

### DRAWING

FIG. 1 is a perspective view of a lighted soft device for the cover of an automobile seat belt.

FIG. 2 is a perspective view of a lighted soft device-showing the inside of the device before it has been secured to a seatbelt.

FIG. 3 is a perspective view of a lighted soft device including a front sheet with opening and selected EL elements.

FIG. 4 is an exploded perspective view of a lighted soft device for a seat belt including battery, circuitry, EL elements, and cover.

FIG. 5 is a perspective view of an alternative embodiment of a lighted soft device for automobile equipment.

FIG. 5a is a perspective view of a second alternative embodiment of a lighted soft device for automobile equipment.

### DETAILED DESCRIPTION

A lighted soft device for an automobile according to the current invention includes a cover for a seat belt, cover for a steering wheel, cover for a seat, cover for a pillow, cover for a dash board, and cover for a car front body. All such covers mainly are made of soft material to let people feel comfortable and offer protective functions to protect automobile equipment from damage caused by scratches, sunshine, humidity, ultra-violet rays, cigarette burning tips, water, coffee, heat, salt etc. The cover may be made of textile, leather, plastic, garments, cloth, or chemical material to make it soft with some features to let people like the appearance and feel comfortable for hot and cold weather.

The current invention provides all these soft cover devices with illumination provided by electroluminescent (hereafter referred to as EL) elements to make a good lighting device for night time driving safety and comfort while people are in a dark environment.

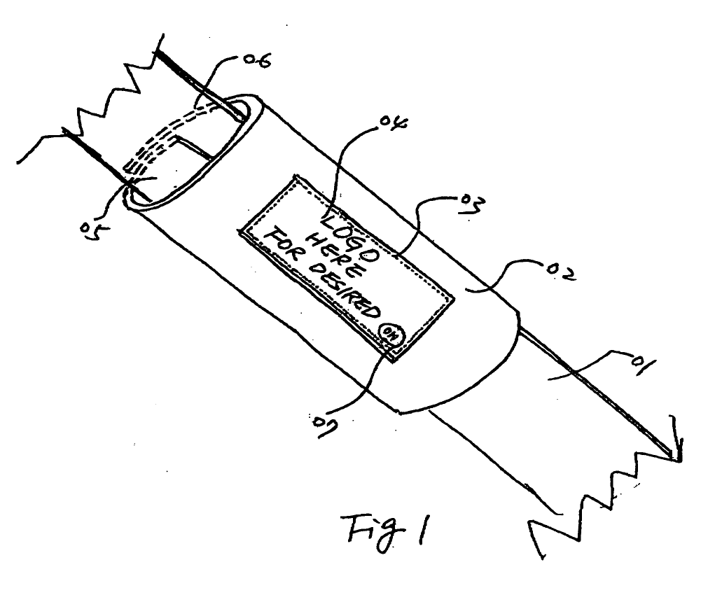

From FIG. 1, the seat belt (01) is a normal automobile seat belt which offers people good safety while driving. However, the seat belt is very uncomfortable so the cover (02) for the seat belt has been created to offer a soft material to drivers and people. The current invention adds a light device to the cover, including one front sheet (04) with a logo, design, indicia, drawing, characters, or colors to improve appearance, and which uses a traditional attachment means (03) which may selected from group consisting of stitching, glue, ultrasonic sealing, hot sealing, solvent, and adhesive, to hold it to the cover (02) surface. One marking (07) indicates the position of the system switch so it can operate an on and off function. The cover (02) can be fastened on the seat belt by Velcro-hook and loop means, and may include tightness adjustable features.

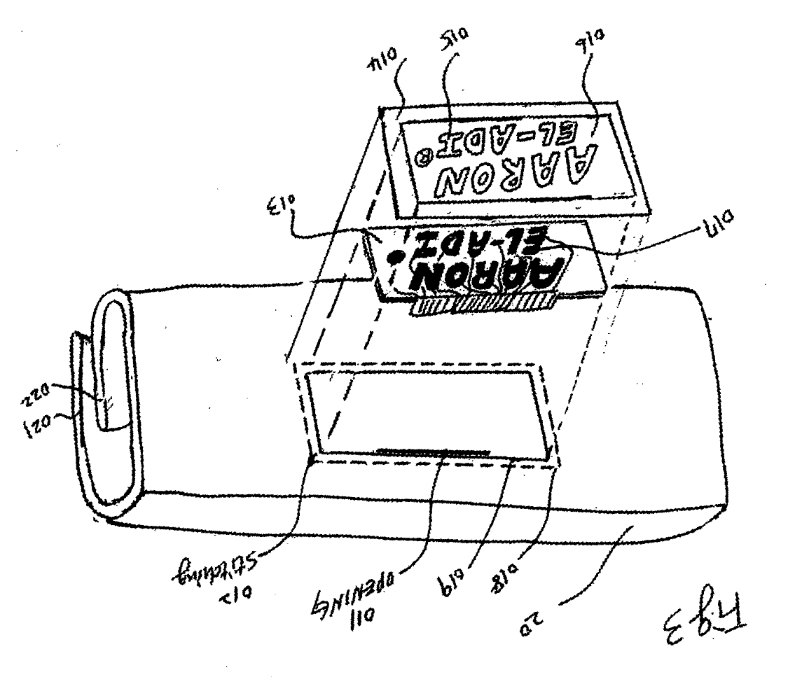

FIG. 3 illustrates a soft lighted device for automobile equipment according to a preferred embodiment that may be used with a safety belt. The soft cover device (20) has two ends (021) (022) which can be fastened together by a Velcro hook-n-loop and also can offer an adjustment for tightness while fastening on the seat belt. The soft cover device (020) has an opening (011) to allow the EL panel (013) electrodes on the inner side to connect with a proper power source (not shown). The EL panel (013) includes selected areas(017) with a phosphor coating, and other areas with no phosphor coating, to save a lot of cost. The phosphor coated areas (017) are positioned with respect to the front sheet's window-area (015) so that selected phosphor areas (017) form the logo “AARON EL-ADI®” when positioned in the window areas (015). The window areas must pass light but it is not necessary that they be openings. They can be made by silkscreen process to let the areas without any ink pass light. They also can be made by a traditional stencil, masking, or filter process. This is the same as disclosed in the current inventor's U.S. Pat. No. 5,572,817. The remaining areas of front sheet (015) can be made as pretty as possible using the most advanced printing techniques, which include printing with grading image, silver color, gold color, powder added printing, and hologram printing, none of which can be achieved by a traditional EL panel making process. This will provide a very nice and valuable appearance in comparison with a traditional EL making process. The wide edge (014) of the front sheet offers a stitchable edge for attachment of the front sheet and EL panel to the cover by a conventional stitching, sewing, hot welding, ultrasonic sealing, a solvent, or a stamping process.

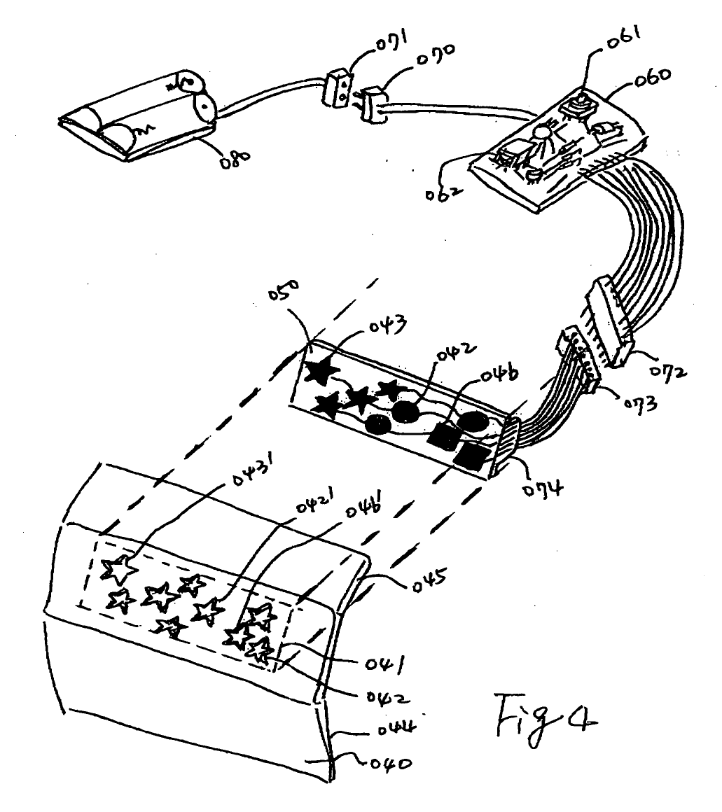

FIG. 4 illustrates an alternative soft lighted device process to make the soft lighted device for the cover (040) of a safety belt or other cover device. The cover surface (040) has a lot of openings (042) each with a desired shape(042′), distance, spacing, figure, indicia, character, and/or size (043′) (046) which allows the inner EL panel's selected areas (043) (042) (046) coated with phosphor to be positioned within the opening position so that light can be emitted out to the viewer. The selected areas (042) (043) (046) are made on one piece of the EL panel substrate (050) with any desired and convenient shape and areas so long as they are bigger than the opening (042) (043′) (046′), and can be round (042), rectangular (046), or star-shaped (043) to make a good light arrangement. The EL panel substrate (050) includes multiple electrodes (074), which may be made while printing the EL conductive layer, and which are connected by conductive means such as an electric wire set with socket (073) to join together with an electric wire and socket (072) and circuit means (060) which has all necessary electric components (061) (062) and other parts to provide a desired lighting function. The circuit means may use a quick connector system (070) (071) to connect with a power source such as a battery holder (080) with batteries (not shown). The reason to use a quick connector system including components (070) (071) and (072) (073) is because the assembly has to pass though the holes on the cover and holes on the pocket. This depends on assembly considerations, however, and is not critical. The circuit means (60) includes a part (061), which may be a switch which allows people to turn on/off the system as required.

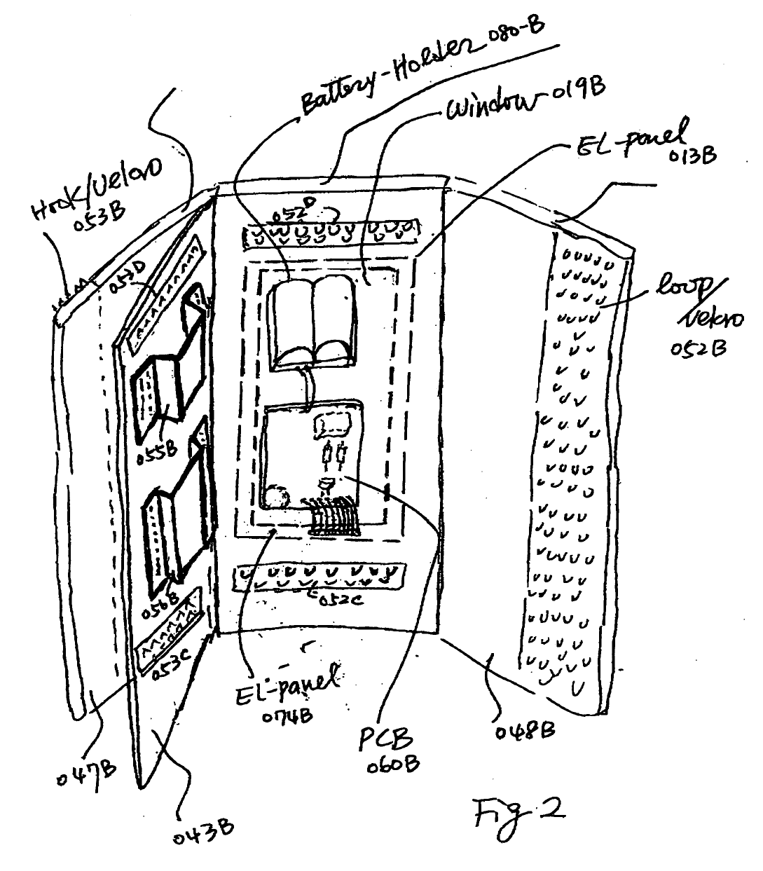

FIG. 2 shows further details of the preferred assembly of a lighted soft device for a safety belt cover. The EL panels (013B) are larger than the window/opening (019B) so that the edge of the EL panel (013B) will not be visible through window. The EL panel's electrodes (074B) are connected with PCB (060B) to provide a signal to turn on/off in response to predetermined functions. The PCB (060B) is connected with power source (080B) by wire and a quick connector system so that it can pass through the hole on the pocket (055B). The EL panel also has a quick connector system to allow it to pass through the hole of pocket (056B). The two pockets may be varied based on design requirements. One also can use double sided tape, Velcro tape, other Hook and Loop devices, glue, or adhesives to fix the PCB (060B) and Batteries Holder (080B) at a desired Location. The preferred two pockets (055B) (056B) are designed to load the battery holder (080B) and circuit (060B). These pockets are on an extra layer piece (043B) which is attached to an inner side of the cover device. Also, a hook and loop device provides close and open features for battery replacement, and a close feature to prevent people from seeing the complicated circuit and ugly inner guts. The two ends of cover (047B) (048B) also have hook and loop means to facilitate installation on safety belt or release from the safety belt. This is of course but one embodiment of the inner assembly, and it will be appreciated that there are many alternative ways to carry out the assembly procedure and meet design requirements.

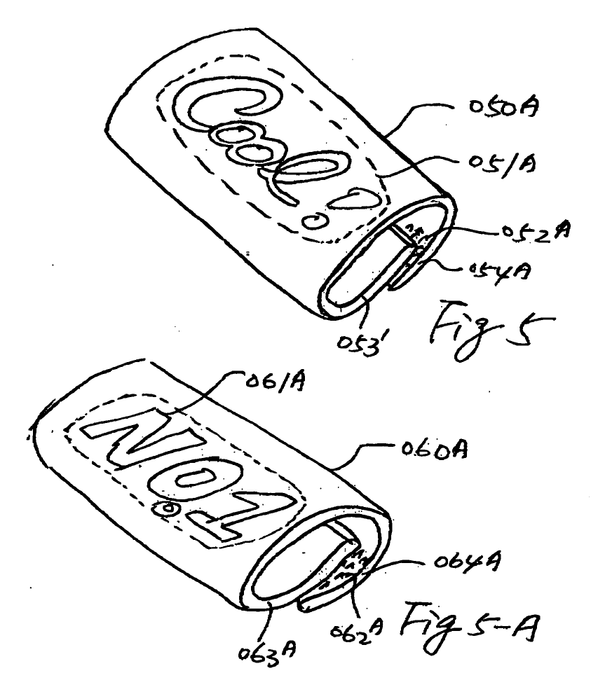

FIG. 5 shows one finished soft lighted device for a safety belt in which the lighting elements and openings form the word “Cool”. FIG. 5a shows another finished soft lighted device for a safety belt in which the lighting elements and openings form a “No. 1”.

1-9. (Canceled)

10. A soft lighted device for automobile equipment, comprising:
at least one electro-luminescent element; and
means including at least one soft material cover for protecting said automotive equipment, said at least one electro-luminescent element being incorporated into and affixed to said at least one soft material cover, at least a part of said soft material cover being arranged to extend around an automotive part and to be secured to the part by securing ends of the soft material cover together.

11. A soft lighted device for automobile equipment as claimed in claim 10, wherein said at least one soft material cover is arranged to protect automotive equipment selected from the group consisting of a seat belt, a steering wheel, a seat, a seat cushion, a dash board, and a front vehicle body.

12. A soft lighted device for automobile equipment as claimed in claim 10, wherein the electro-luminescent element is a tubular electro-luminescent element arranged to emit light in a variety of directions.

13. A soft lighted device for automobile equipment as claimed in claim 10, wherein a material of the soft material cover is selected from the group consisting of paper, leather, PVC, plastic, metal foil, foam, textile, garment, cloth, and chemical items.

14. A soft lighted device for automobile equipment as claimed in claim 10, further comprising circuit means including an integrated circuit for causing said electro-luminescent element to turn on and off to provide predetermined lighting effects.

15. A soft lighted device for automobile equipment as claimed in claim 10, wherein said electro-luminescent element is an electro-luminescent panel having a plurality of selected phosphor coated areas positioned behind multiple windows cut in said soft material cover.

16. A soft lighted device for automobile equipment as claimed in claim 10, wherein said electro-luminescent element is a tubular electro-luminescent element arranged to providing piping, decorative straps, and linear lighting arrangements for said cover.

17. A soft lighted device for automobile equipment as claimed in claim 10, wherein said soft material cover includes openings through which light from said electro-luminescent element is emitted.

18. A soft lighted device for automobile equipment as claimed in claim 10, wherein said electro-luminescent element includes wire type attachment means for fixing said electro-luminescent element on said soft material cover.
